(19) United States
(12) Patent Application Publication
(10) Pub. No.: US 2010/0275823 A1
(43) Pub. Date: Nov. 4, 2010

(54) Special Pyrogen Waste treatment and electrical generation combination of systems

(75) Inventor: Terry J Pahls, Anderson, IN (US)

Correspondence Address: RITCHISON LAW OFFICES, PC, 115 EAST NINTH STREET - SUITE A, ANDERSON, IN, 46016-1507, US

(73) Assignee: I POWER ENERGY SYSTEMS, LLC

(21) Appl. No.: 12/772,942

(22) Filed: May 3, 2010

Related U.S. Application Data
(60) Provisional application No. 61/175,389, filed on May 4, 2009.

(51) Int. Cl. F23B 30/00; F23K 3/00; H02K 7/18

(52) U.S. Cl. 110/233; 110/327; 290/1 A

(57) ABSTRACT

A Pyrogen waste treatment and electrical generation combination of systems which is comprised of a combination of pyrolytic combustion systems with a feed stock and a means to convey and pre-treat the feedstock to the combustion system, where the combustion system produces a syngas; co-generators produce hot water and electrical power; and where the co-generator systems may be powered from syngas. It features a means to transfer the syngas to the cogeneration hot water and electrical power generator; a means to transfer hot water and electricity from the cogeneration hot water and electrical power generator to the pyrolytic combustion system; and a means to transfer generated electricity from the co-generator to an end user. It provides significant benefits compared to other devices and is used for a symbiotic and synergistic combination of essentially two systems—a pyrolytic combustion system and a cogeneration electrical power generator.

### CROSS-REFERENCE TO RELATED APPLICATIONS

This application claims the benefit of Provisional Patent Application Ser. No. 61/175,389 filed May 4, 2009 by Terry J. Pahls and entitled “Special Pyrogen waste treatment and electrical generation combination of systems”.

### FIELD OF INVENTION

This uniquely improved device relates to a “Special Pyrogen waste treatment and electrical generation combination of systems” for use in many ways as described below. Particularly this new “Special Pyrogen waste treatment and electrical generation combination of systems” is related to significantly improved component, materials and methods to improve the overall synergy between a pyrolysis thermal combustion system providing fuel and electricity cogeneration system using the fuel to make electrical power and return heat back to the pyrolysis system.

### FEDERALLY SPONSORED RESEARCH

None.

### SEQUENCE LISTING OR PROGRAM

None.

### BACKGROUND-FIELD OF INVENTION AND PRIOR ART

### A. Introduction of the Problems Addressed

The problem solved involves one related to a long felt need in both the electricity generation and waste treatment industries. Science and engineering leaders for the last two (2) centuries have attempted to provide a waste treatment technology that eliminates waste by converting all or part of it to a re-useable energy form with minimal byproducts. Likewise, efforts to find new and cleaner energy resources for conversion to electricity have been sought. Some of each of these endeavors—waste treatment and electricity generation have overlapped development and needs and have provided a potential synergy in using waste products being treated to provide fuel to produce electricity. As far as known, there are no other improved or enhanced pyrolytic and electrical cogeneration systems devices at the present time which fully provide the advantages and objectives of the “Special Pyrogen waste treatment and electrical generation combination of systems”. It is believed that this combination of systems is made with improved configuration of physical connections, of a durable design, with a better assembly, and with better material selections as compared to other waste treatment systems and power systems for stationary generation of electricity and production of hot water.

### B. Prior Art

The historical technology focused on devices that only helped with fairly expensive and complex designs. Hitherto there are no economical means used for the transfer of waste energy into electricity. A method was issued as U.S. Pat. No. 3,993,458 (1976) to Antal, Jr. The method called a method for producing synthetic fuels from solid waste had overall features and combinations that are very complex. It also showed no feedback from the electricity generator system as the instant application provides.

Another device called conversion of organic waste material showed an apparatus and method which was issued as U.S. Pat. No. 4,098,649 (1978) to Redker. The overall features and combinations of the device show an apparatus and the method of converting organic material such as that separated from municipal and industrial waste into useful products by using a form of an extruder in a continuous destructive distillation process and in which the material being processes is compressed in the extruder in the absence of air and is heated to carefully controlled temperatures in separate zones to extract different products from each of the zones. It is very complex and associated with a series of multiple stages and auxiliary devices rather than simple devices as part of the transformation means. The device differs greatly from Pahl's invention in that is uses a complex system as opposed to a simple use of the produced gas and the return of the heated water.

Another device by Manikowski, Jr. et al is shown in U.S. Pat. No. 5,899,175 (1999). This device is a Hybrid electric-combustion power plant. It fails to anticipate the present device and the compact/non-complex configuration and the distinct feedback of the hotwater to support the overall system.

A Process and device for pyrolysis of feedstock in U.S. Pat. No. 6,048,374 (2000) was issued to Green. Here the prior art teaches unique and advantageous systems for gasifying and/or liquefying biomass. The systems of the subject invention utilize a unique design whereby heat from a combustion chamber is used to directly gasify or liquefy biomass. In a preferred embodiment, the biomass is moved through a reactor tube in which all the gasification and/or liquefaction takes place. Preferably, char exits the biomass reactor tube and enters the combustion chamber where the char serves as fuel for combustion. The combustion chamber partially surrounds the reactor tube and is in direct thermal contact with the reactor tube such that heat from the combustion chamber passes through the reactor wall and directly heats the biomass within the reactor tube. No simplistic system with hot water feedback is anticipated or demonstrated by Green.

A more recent process involved a U.S. Pat. No. 6,209,494 (2001) issued to Manikowski, Jr. that teaches a hybrid fuel-cell electric-combustion power system using complete pyrolysis. Here the invention shows a complex procedure for producing mechanical power and a hybrid power generation unit for practicing such a process. In particular, the procedure uses a thermal or catalytic cracker to crack or to pyrolyze (partially or completely) a liquid or gaseous petroleum fuel to produce a primary gaseous stream primarily containing hydrogen (and likely methane or other short-chain hydrocarbons). The hydrogen may be used in a fuel cell to produce electricity, which electricity is used in a linear or rotary electric motor. The concept and process is very complex viewed from the Pahl's application.

Finally, an in situ thermal processing of a hydrocarbon containing formation to produce oxygen containing formation fluids is taught by U.S. Pat. No. 6,966,372 (2005) issued to Wellington, et al. This process taught a hydrocarbon containing formation may be treated using an in situ thermal process. A mixture of hydrocarbons, H.sub.2, and/or other formation fluids may be produced from the formation. Heat may be applied to the formation to raise a temperature of a portion of the formation to a pyrolysis temperature. The mixture produced from the formation may contain condensable hydrocarbons, with some of the hydrocarbons being oxygen containing hydrocarbons. The system shown is extremely complex as compared to the Pahl's application.

The uniqueness as to other prior art should be evident to one skilled in the art of electrical power generation and hot water using waste energy from a pyrolytic conversion systems. The combination is new and unique and not anticipated or obvious in view of other waste and cogeneration systems. The details of the combination of devices and systems were described above.

### SUMMARY OF THE INVENTION

A “Special Pyrogen waste treatment and electrical generation combination of systems” has been developed for use with Stationary Power Generation Systems. Particularly this new “Special Pyrogen waste treatment and electrical generation combination of systems” is related to a series of improved components, new combinations and a symbiotic and synergistic combination of essentially two systems—a pyrolytic combustion system and a cogeneration electrical power generator. The pyrolytic combustion system uses and treats various waste materials, uses electricity and uses heat. It in turn produces various resultant products including oil, char, ash, combusted gases, and pyrogas or syngas. The cogeneration electrical power generator is an electrical power generation system that use syngas, natural gas, gasoline or some other fuel and produces useable electricity, hot combusted gas, and hot water. The synergy is a resultant of the pyrolytic combustion system needing a heat source and electricity from the co-generator and the co-generator needing syngas from the pyrolytic combustion system. Hence a cooperative combination of systems result.

The preferred embodiment of a “Special Pyrogen waste treatment and electrical generation combination of systems” is comprised essentially of:

a). at least one pyrolytic combustion systems with a feed stock and a means to convey and pre-treat the feedstock to the pyrolytic combustion system and in which the pyrolytic combustion system produces a syngas;

b). at least one co-generators that produce hot water and electrical power in which the co-generator systems, with a high temperature exhaust gas, may be powered from an energy source syngas;

c). a means to transfer the resultant syngas from the pyrolytic combustion system to the co-generator;

d). a means to transfer electricity from the co-generator to the pyrolytic combustion system;

e) a means to transfer generated electricity from the co-generator to an end user;

f) a means to transfer hot water from the co-generator to an end use device; and

g) a means to transfer the high temperature exhaust gas to the pyrolizer for a use wherein feedstock is fed into the pyrolytic combustion system and electricity is produced to the end user by the cogeneration electrical power generator which has hot water and high temperature exhaust gas as a by product.

### OBJECTS AND ADVANTAGES

There are several objects and advantages of the “Special Pyrogen waste treatment and electrical generation combination of systems”. The following TABLE A summarizes various advantages and objects of the “Special Pyrogen waste treatment and electrical generation combination of systems”. This list is exemplary and not limiting to the many advantages offered by this new combination of systems.

TABLE A
Objects and Advantages

| ITEM | BENEFIT |
|---|---|
| 1. | Handles nearly any waste sludge for the production of |
| | electricity |
| 2. | Is fully automated |
| 3. | Is modularized for various loads and multiple |
| | configurations |
| 4. | Can be “dialed-in” and adjusted for different types |
| | of waste specific needs and BTU production |
| 5. | Does not require incineration rather it is a |
| | decomposition of organic materials |
| 6. | Is a continuous input and output system |
| 7. | Does not require special sand or fluidized bed |
| | equipment |
| 8. | Is easy to package |
| 9. | Can be sold and distributed retail or wholesale |

Other advantages and additional features of the present “Special Pyrogen waste treatment and electrical generation combination of systems” will be more apparent from the accompanying drawings and from the full description of the device. For one skilled in the art of devices and improvements for electrical power generation and hot water using waste energy from a pyrolytic conversion system, it is readily understood that the features shown in the examples with this combination system are readily adapted for improvement to other types of waste treatment and power conversion systems.

### DESCRIPTION OF THE DRAWINGS

### Figures

The accompanying drawings, which are incorporated in and constitute a part of this specification, illustrate a preferred embodiment for the “Special Pyrogen waste treatment and electrical generation combination of systems”. The drawings together with the summary description given above and a detailed description given below serve to explain the principles of the “Special Pyrogen waste treatment and electrical generation combination of systems”. It is understood, however, that the device is not limited to only the precise arrangements and instrumentalities shown.

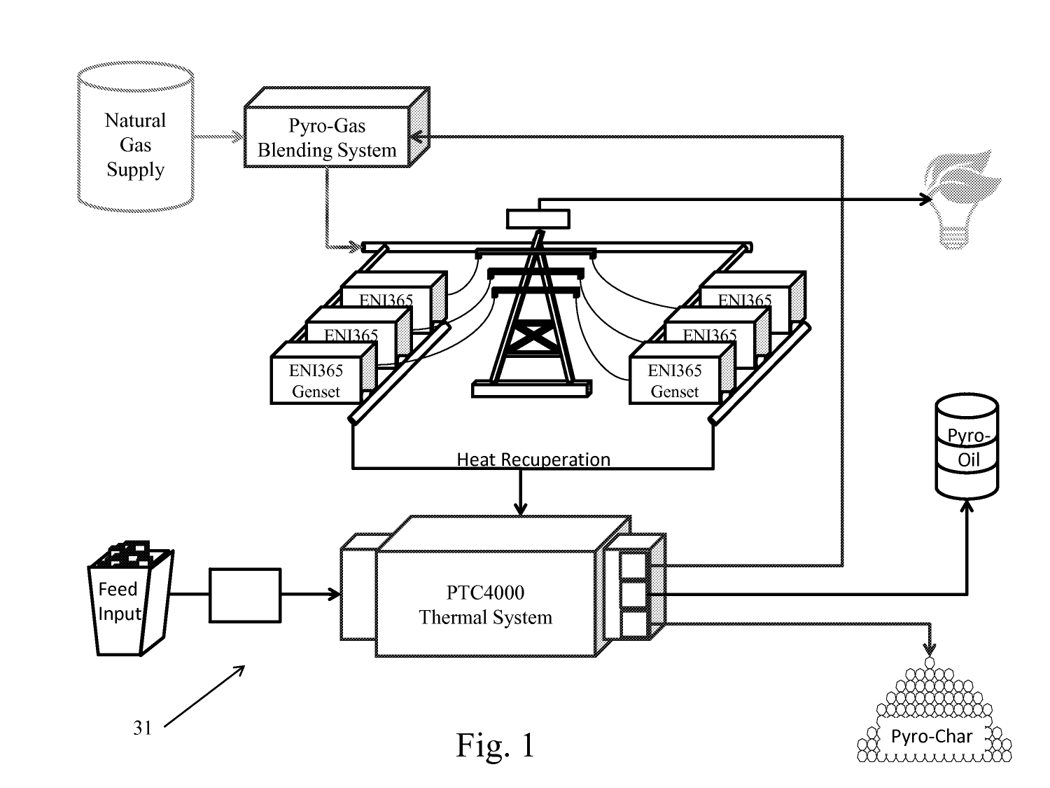

FIG. 1 depicts the overall general drawing of the “Special Pyrogen waste treatment and electrical generation combination of systems”.

FIG. depicts the drawing of the “Special Pyrogen waste treatment and electrical generation combination of systems” with various components noted.

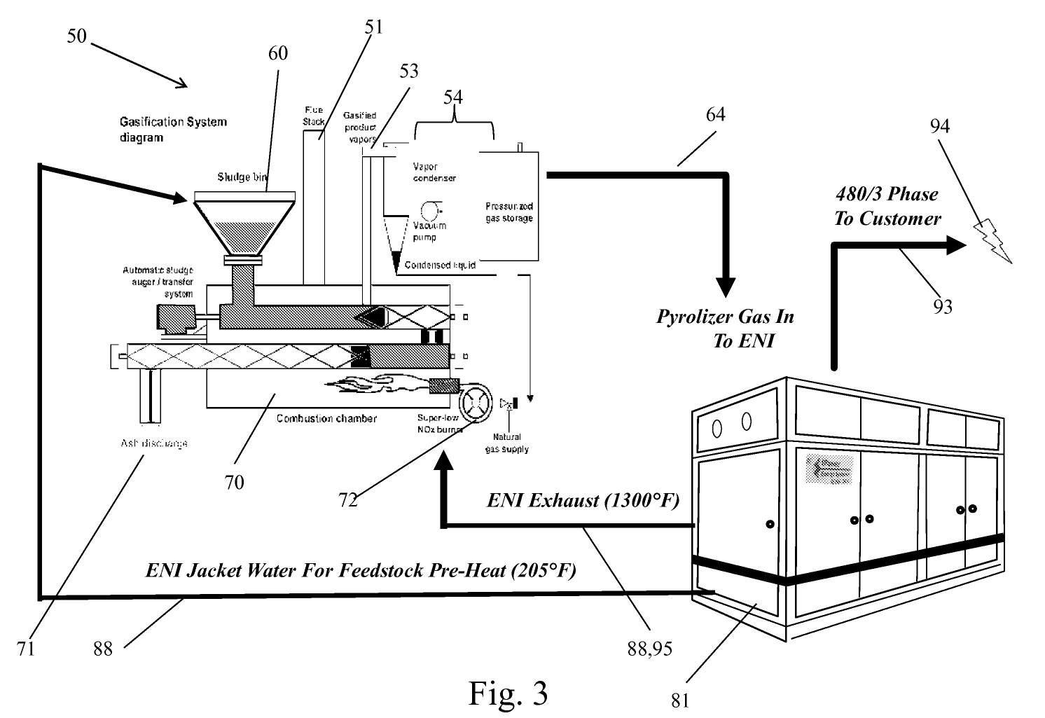

FIG. 3 is another drawing of the “Special Pyrogen waste treatment and electrical generation combination of systems” with additional components and inter-connections shown.

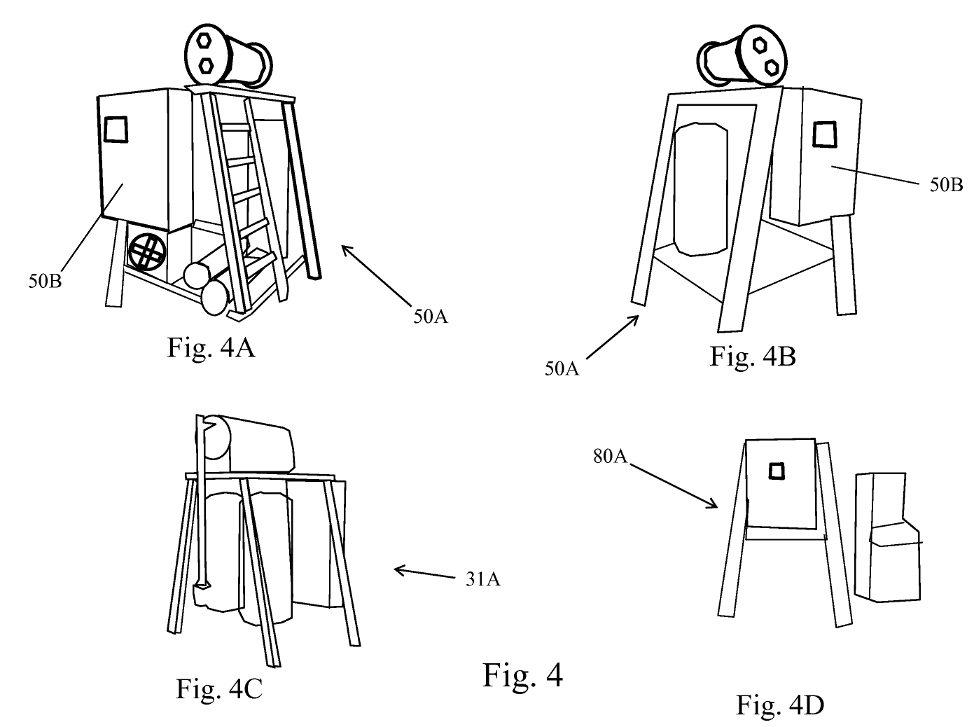

FIGS. 4 A through 4 D are component details of the prototype “Special Pyrogen waste treatment and electrical generation combination of system”.

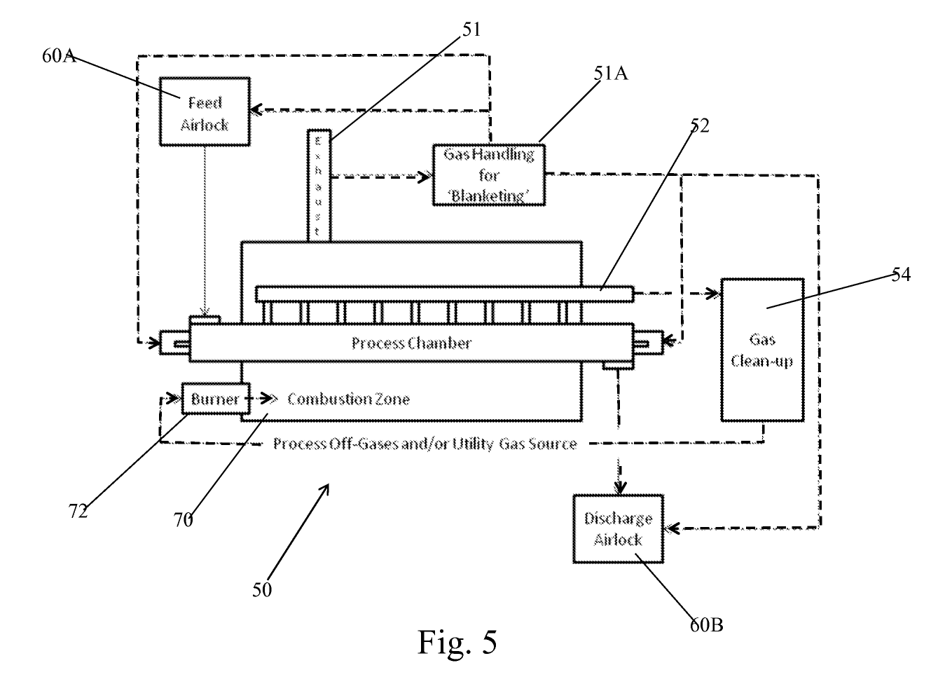

FIG. 5 shows a schematic of the pyrolytic thermal combustion system with components and features shown.

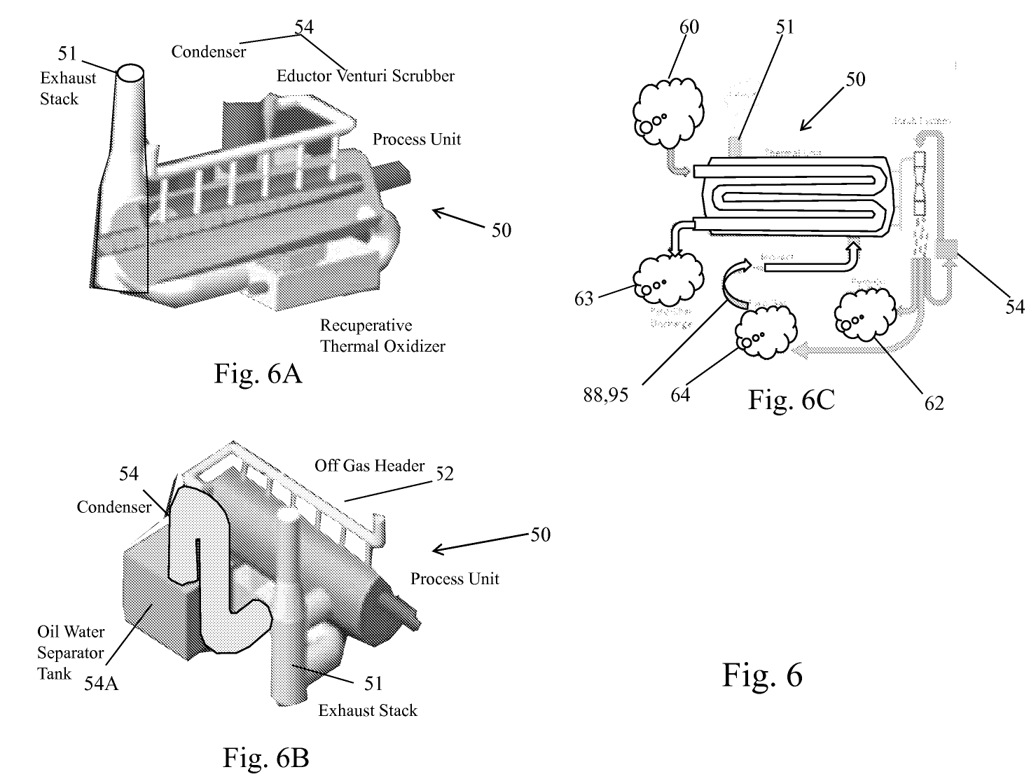

FIGS. 6 A through 6 C show sketches of the pyrolytic thermal combustion system with other components and features shown.

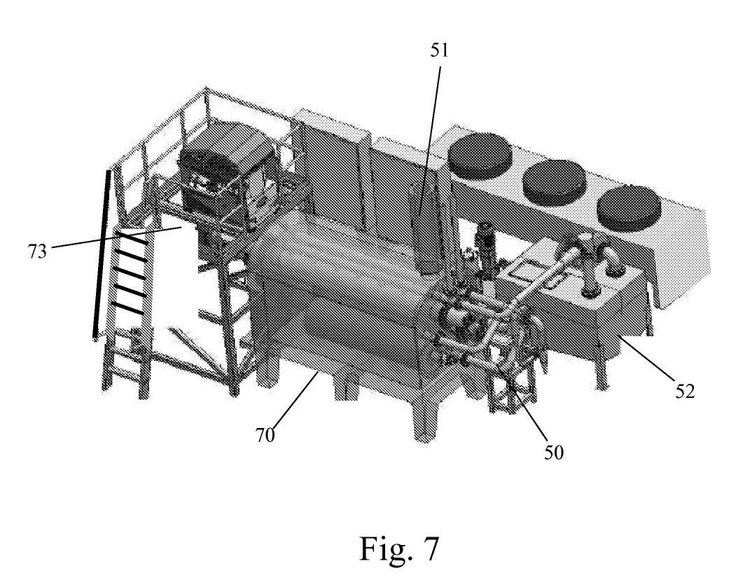

FIG. 7 is an isometric drawing of a typical pyrolytic thermal combustion system with significant features noted.

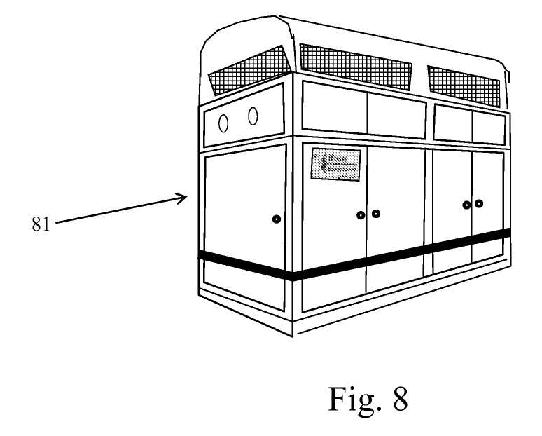

FIG. 8 is an electricity cogeneration unit used with the pyrolytic thermal combustion system to produce electricity.

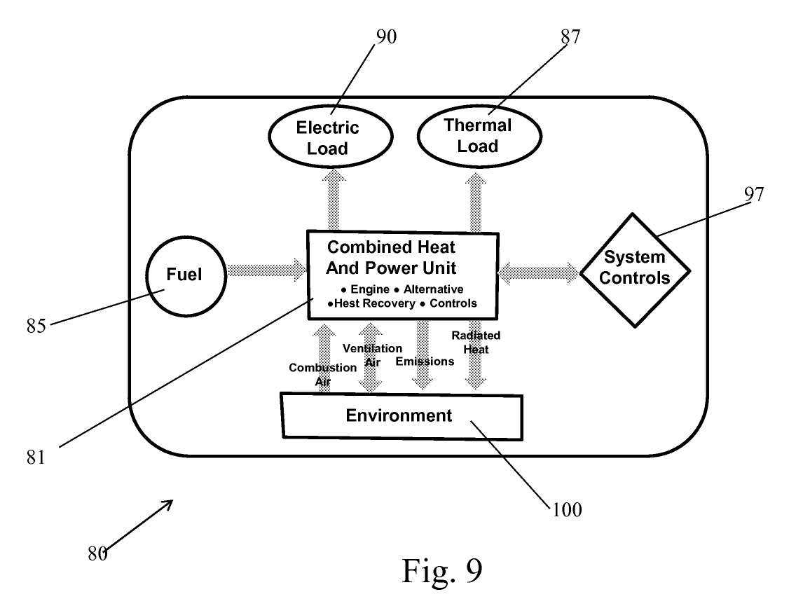

FIG. 9 is a sketch showing a combined electrical power and heat unit showing the general main features.

### DESCRIPTION OF THE DRAWINGS

### Reference Numerals

The following list refers to the drawings:

| Ref # | Description |
|---|---|
| 31 | Pyrogen-pyrolysis/electricity co-generation system |
| 31A | Pyrogen-pyrolysis/electricity co-generation |
| | prototype system |
| 50 | Pyrolytic Thermal Conversion System |
| 50A | Pyrolytic Thermal Conversion Prototype System |
| 50B | Control means for a Pyrolytic Thermal Conversion |
| | Prototype System |
| 51 | Exhaust Gas stack or flue |
| 51A | Exhaust gas collection means for airlock/blanket |
| | supply |
| 52 | Off gas headers |
| 53 | Inert Product vapors (from PTC-50) |
| 54 | Product vapor treatment and storage system |
| 54A | Oil-water separation tank |
| 60 | Feedstock/waste material input |
| 60A | Feedstock Airlock (combustion air blanket) |
| 60B | Discharge Airlock (combustion air blanket) |
| 61 | Pre-treat/pre-heat method for feedstock |
| 62 | Pyro-oil output |
| 63 | Pyro-Char output |
| 64 | Pyro/syngas supply |
| 70 | Combustion chamber |
| 71 | Ash discharge |
| 72 | NOX Burner |
| 73 | Centrifuge or dewatering means |
| 80 | Electrical power generation system |
| 80A | Prototype generation system |
| 81 | Generation sets |
| 83 | Natural gas or equal supply |
| 84 | Pyrogas blending station |
| 85 | Pyrogas feed means |
| 86 | Feed gas header to one or more generator sets |
| 87 | Hot water headers |
| 88 | Heat recuperation feed from headers to PTC 50 |
| 90 | Electricity transmission means such as power cables |
| | of buss duct |
| 91 | Electrical collection and support means |
| 92 | Protection relay and switch gear |
| 93 | Collected power transfer means |
| 94 | Electricity supply to user |
| 95 | Co-gen exhaust gas |
| 96 | Co-gen example specifications |
| 97 | Co-gen system control means |
| 98 | Components and modules of a typical Pyrolytic Thermal |
| | Conversion System |
| 100 | Environment |

### DETAILED DESCRIPTION OF PREFERRED EMBODIMENT

The present device is a “Special waste treatment and electrical generation combination of system” 31 called Pyrogen. A “Special Pyrogen waste treatment and electrical generation combination of systems” has been developed for use with Stationary Power Generation Systems. Particularly this new “Special Pyrogen waste treatment and electrical generation combination of systems” is related to a series of improved components, new combinations and a symbiotic and synergistic combination of essentially two systems—a pyrolytic combustion system and a cogeneration electrical power generator. The pyrolytic combustion system uses and treats various waste materials, uses electricity and uses heat. It in turn produces various resultant products including oil, char, ash, combusted gases, and pyrogas or syngas. The cogeneration electrical power generator is an electrical power generation system that use syngas, natural gas, gasoline or some other fuel and produces useable electricity, hot combusted gas, and hot water. The synergy is a resultant of the pyrolytic combustion system needing a heat source and electricity from the co-generator and the co-generator needing syngas from the pyrolytic combustion system. Hence a cooperative combination of systems result.

The preferred embodiment of a “Special Pyrogen waste treatment and electrical generation combination of systems” is comprised essentially of:

A Special Pyrogen waste treatment and electrical generation combination of systems 31 for treating waste and cogenerating electricity comprised of

a). at least one pyrolytic combustion systems with a feed stock and a means to convey and pretreat the feedstock to the pyrolytic combustion system and in which the pyrolytic combustion system produces a syngas;

b). at least one co-generators that produce hot water and electrical power in which the co-generator systems, with a high temperature exhaust gas, may be powered from an energy source syngas;

c). a means to transfer the resultant syngas from the pyrolytic combustion system to the co-generator;

d). a means to transfer electricity from the co-generator to the pyrolytic combustion system;

e) a means to transfer generated electricity from the co-generator to an end user;

f) a means to transfer hot water from the co-generator to an end use device; and

g) a means to transfer the high temperature exhaust gas to the pyrolizer for a use wherein feedstock is fed into the pyrolytic combustion system and electricity is produced to the end user by the cogeneration electrical power generator which has hot water and high temperature exhaust gas as a by product.

There is shown in FIGS. 1-9 a complete operative embodiment of the “Special Pyrogen waste treatment and electrical generation combination of systems” 31. In the drawings and illustrations, one notes well that the sketches and drawings demonstrate the general configuration of the present concept and the prior art for this invention. These drawings and illustrations are described in detail below.

The accompanying drawings, which are incorporated in and constitute a part of this specification, illustrate a “Special Pyrogen waste treatment and electrical generation combination of systems” 31 that is preferred. The drawings together with the summary description given above and a detailed description given below of the drawings and illustrations serve to explain the principles of the “Special Pyrogen waste treatment and electrical generation combination of systems” 31. It is understood, however, that the “Special Pyrogen waste treatment and electrical generation combination of systems” device 31 is not limited to only the precise arrangements and instrumentalities shown.

FIG. 1 depicts the overall general drawing of the “Special Pyrogen waste treatment and electrical generation combination of systems” 31. The system consist of a pyrolysis process 50, developed for converting organic waste materials to high energy gaseous fuel for use in prime power electric generators 81. The “Special Pyrogen waste treatment and electrical generation combination of systems” 31 will take carbon based waste, either municipal solid waste (MSW) or waste from business and industry, and convert it into clean electricity. This conversion plays a major role in the reduction of rubbish going to landfill and potentially make a significant contribution to the overall electricity supply.

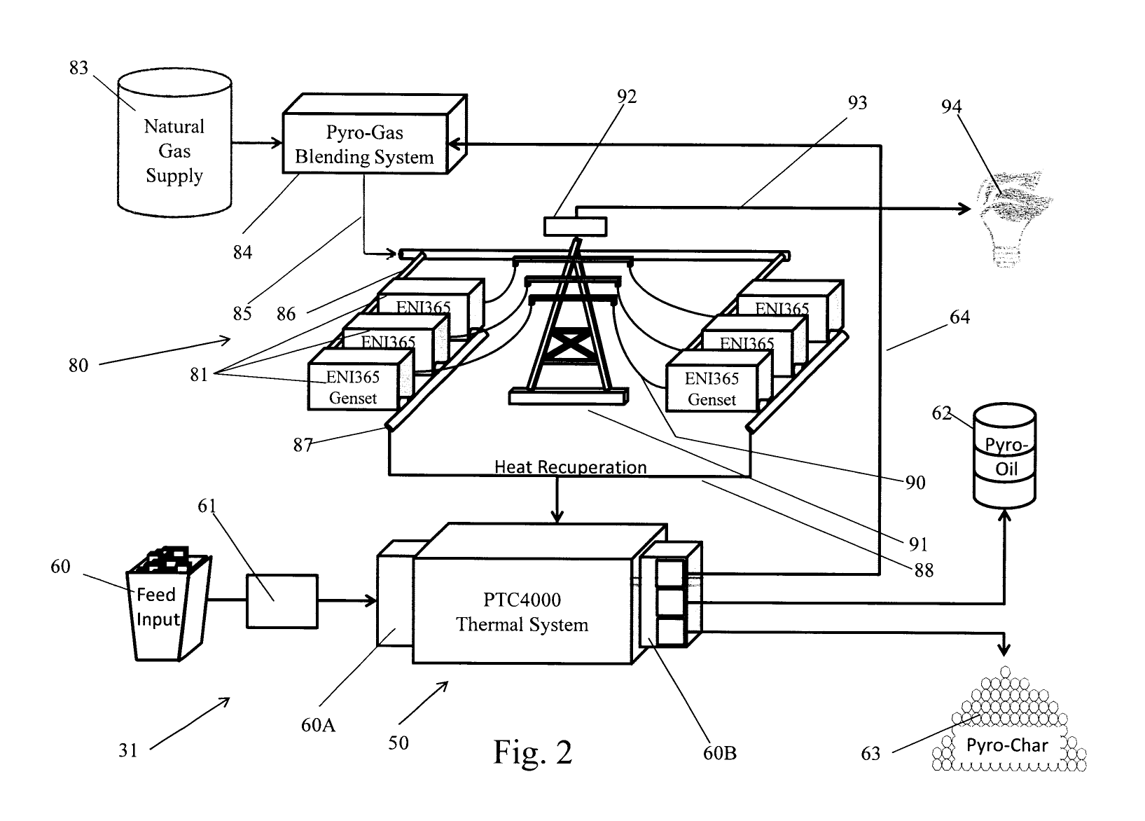

FIG. 2. depicts the drawing of the “Special Pyrogen waste treatment and electrical generation combination of systems” 31 with various components noted. Here the feed stock 60 is fed to the pyrolytic combustion system 50 through an optional preheat or pre-treat means 61. The means 61 may be catalysts, common dryers, centrifuges and the like to prepare the feedstock 60 for optimum conversion to syngas/pyrogas and other resultant products. The feedstock 60 potentially passes the pre-heat/pre-treat 61 and then enters the pyrolytic combustion system 50 through a blanket or airlock 60A of non-combustible, inert gas from another part of the system 31. This permits the feedstock 60 to enter the pyrolytic combustion system 50 without the presence of any oxygen. Hence this allows the pyrolytic conversion to proceed without a need for a vacuum or mechanical means to remove the oxygen. One skilled in the art of pyrolysis knows well that Pyrolysis is the chemical decomposition of organic materials by heating in the absence of oxygen or any other reagents, except possibly steam. The products of the pyrolytic combustion system 50 exit through another blanket 60B similar to the entry blanket 60A. The exiting materials from the pyrolytic combustion system 50 include pyrochar 63, pyro oil 62 and the pyrogas or syngas 64. The pyrogas 64 is transferred or conveyed to the pyrogas blending system 84. One skilled in the art of off-gases from such pyrolytic devices well knows and appreciates that the syngas may be a special biogas, a methane derivative, or a new composite gas resultant of the pyrolytic system. The type of gas and BTU value is directly related to the type of waste processed. The scope and spirit of the instant combination of the pyrolytic system and the electrical and hot water generator anticipates various combinations and permutations of the specific off gas and BTU value as technology in this discipline advances. Here the syngas/pyrogas 64 is either held for use by the gensets 81 or blended with natural gas or other gas for powering the gensets 81. The natural gas supply 83 is made available as a back-up if for some reason the pyrogas 64 is not available. Likewise, it is a part of the scope of this patent to consider various forms of gases and fuels whether a natural or synthetic gas to be available to power the overall cogeneration electrical power generator 81. After the blending, or as a pure form, the syngas or natural gas is transferred to the gensets 81 by a means 85 and onto headers 86 when there is a plurality of gensets 81. The gas is then used in the system 80 to produce electricity and hot water and exhaust gas which is used by the pyrolizer. The hot water and exhaust gas from the cogeneration electrical power generator 80 is transferred back to the pyrolytic combustion system 50 by a heat recuperation means 88. Likewise the cogeneration electrical power generator 80 produces electricity which is collected from the genset(s) 81 by a means 90 such as multiple cables or ducts and then transferred by a means of support and collection 91 to a protection relay and switchgear 92 or the equivalent. The electricity is then conducted by a means 93 to the end user or process 94.

FIG. 3 is another drawing of the “Special Pyrogen waste treatment and electrical generation combination of systems” 31 with additional components and inter-connections shown. The pyrolytic combustion system 50 shows the combustion chamber 70, the NOx burner 72, the ash discharge 71, the feed stock hopper 60, the exhaust stack or flue 51, the gas product vapors 53, the subsequent treatment condenser and storage 54, and the pyro/syngas supply line 64 from the pyrolytic combustion system 50 to the cogeneration electrical power generator 81. The pyro/syngas supply line 64 provides fuel to the cogeneration electrical power generator 81. The genset 81 then provides electricity feed 93 to the end user 94. Likewise, the cogeneration electrical power generator system 80 provides an high temperature exhaust gas feed 95 (up to 1300 degrees Fahrenheit of clean, hot gas) and the hot water (up to 600 degrees Fahrenheit) circulation 88 to the pyrolytic combustion system 50.

FIGS. 4 A through 4 D are component details of the prototype “Special Pyrogen waste treatment and electrical generation combination of system”. FIGS. 4 A and 4B show the prototype pyrolytic combustion system 50A and the control panel 50B. FIG. 4C shows the full prototype of the “Special Pyrogen waste treatment and electrical generation combination of systems” 31A. FIG. 4D shows the prototype cogeneration electrical power generator 80A for the prototype system. These prototypes were used to confirm the capability to combine the pyrolytic thermal combustion system with the genset system to produce a synergy and a non-anticipated and unique combination of systems for turning waste products into electricity.

FIG. 5 shows a schematic of the pyrolytic thermal combustion system 50 with components and features shown. Here the feed stock 60 is isolated by an airlock 60A from the process chamber. The combusted gases pass out the flue or exhaust stack 51 to a collection and distribution means 51A. Next the combusted and inert gases are split to return to the intake airlock 60A and the output airlock 60B. From the process chamber of the pyrolytic combustion system 50, the outgas header 52 “collects” the moisture and other gases that may have syngas with high BTU content. These outgases are conveyed through the header 52 on to gas clean-up means 54 with condensers, scrubbers and the like. The high BTU gases are then conveyed to the cogeneration electrical power generator system 81 or to the burner 72 or both. The burner is then fired to provide heat to the combustion zone 70.

FIGS. 6 A through 6 C show sketches of the pyrolytic thermal combustion system 50 with other components and features shown. FIGS. 6 A and 6 B show the pyrolytic combustion system 50 with the product vapor and storage means 54, the exhaust stack 51, the off gas header 52, and the oil/water separator tank 54A. FIG. 6 C shows additional details and features of the pyrolytic combustion system 50 with the output products of the pyro char 63, the pyro gas 64, the pyro oil 62, as well as the components aforementioned. Typical components and modules of the pyrolytic combustion system 50 are shown in the Table list 98. This system has various feed stocks 60 introduced to the system 31. These feed stocks 60 include for example and not limitation wastes such as shown in Table B:

TABLE B
Typical Continuous Feed Unit Components (Item 98)

| ITEM | Description |
|---|---|
| 1 | Sludge feed hopper and Mixer |
| 2 | Sludge feed conveyor |
| 3 | Thermal box with specialized sludge processing chamber |
| 4 | Eductor Venturi exhaust scubber |
| 5 | Vapor Condenser |
| 6 | Thermal oxidation zone with primary with heating option |
| 7 | Oil/water separation tank |
| 8 | Excess Syngas to power generation unit |
| 9 | Central exhaust stack |
| 10 | Heat recovery |

FIG. 7 is an isometric drawing of a typical pyrolytic thermal combustion system 50 with significant features noted. Features and components in this isometric include the centrifuge discharge 73 feeding into the pyrolytic combustion system 50; the thermal conversion chamber 70; the multi-stage processing tubes 50; the off-gas scrubbing system 54 and headers 52 and the exhaust or flue 51.

FIG. 8 is an electricity cogeneration unit 81 used with the pyrolytic thermal combustion system 50 to produce electricity. The unit 81 may be described, for example and not limitation as an ENI 65 65 kW Low BTU Continuous Duty Generator Package. The Energy Now ENI 65 Low BTU is a prepackaged on site energy system which utilizes a GM natural gas engine. The ENI 65 Low BTU can increase efficiency at the customer site by utilizing the valuable syngas/pyrogas or methane gas that would normally be wasted or flared. Combined Heat and Power (CHP) technology recovers waste heat that can be used to reheat digesters or dry media is applicable. This reduces over all energy consumption.

The two systems essentially make-up the “Special Pyrogen waste treatment and electrical generation combination of systems” 31.

Along with the typical genset unit 81 is a table of specifications 96 for the electrical power generation and hot water using waste energy from a pyrolytic conversion system 80. These specifications 96 include for example and not limitation wastes such as shown in Table C:

TABLE C
Typical Specifications and components for electrical
power generation and hot water (Item 96)

GM 3.0 L Vortec industrial engine
High efficiency synchronous generator
Full engine heat recovery (CHP)
Low noise (68 db(A) @ 7M)
Fully automatic functional controls
Automatic alarms & shutdown protection
Grid parallel/grid isolated capability
480/277 Vac 3 Phase 60 Hz power
Weather protected for outdoor siting
Fully lockable
Automatic engine oil replenish system
5 gallon reserve engine oil tank
STANDARD FEATURES
All data based on ISO standard conditions of 29.54″ Hg
barometric pressure, 77 deg F
ambient air temperature, 30% relative humidity.
The values in this specification are subject to a tolerance
of +/− 5%
OPTIONAL FEATURES ENI 25 NATURAL
GAS PERFORMANCE
General
Electrical Output 23 kW
Electrical Efficiency 28.0%
Total Efficiency 86.5%
Fuel
Heat Rate (LHV) 12,826 BTU/kWhr
Rated Fuel 910 BTU/cu ft
Required Fuel Pressure .25 min psig
CHP
Total Heat Available 172,500 BTU/hr
Standard Recovery Temp 197° F.
Normal Coolant Flow 13 gpm
Engine Operation
Operating Speed 1800 RPM
Power At Full Output 32 HP
Emissions
NOX 0.15 g/bhp-hr
CO 0.60 g/bhp-hr
NMHC 0.15 g/bhp-hr
Remote monitor
Isolation CHP heat exchanger
Load dump radiator
Multiple voltages
Induction generator
Premium noise package
Site controller
Service packages

FIG. 9 is a sketch showing a combined electrical power and heat unit system 80 showing the general main features. Here the intake fuel 85 such as natural gas, pyro gas or a blend 85 is indicated. The gas 85 is fed to the unit 81 and the output is electricity to an electrical load 90 and hot water to a thermal load 87. A control system 97 is required for the electrical power generation and hot water using waste energy from a pyrolytic conversion system 80. Likewise various interfaces occur between the system 80 and the environment 100 as depicted in the diagram.

All of the details mentioned here are exemplary and not limiting. Other specific components specific to describing a “Special Pyrogen waste treatment and electrical generation combination of systems” 31 may be added. For one skilled in the art of devices and improvements for electrical power generation and hot water using waste energy from a pyrolytic conversion system, it is readily understood that the features shown in the examples with this mechanism are readily adapted for improvement to other types of waste treatment and cogeneration systems.

### OPERATION OF THE PREFERRED EMBODIMENT

The “Special Pyrogen waste treatment and electrical generation combination of systems” 31 has been described in the above embodiment. The manner of how the device operates is described below. One skilled in the art and field of electrical power generation and hot water using waste energy from a pyrolytic conversion system will note that the description above and the operation described here must be taken together to fully illustrate the concept of the “Special Pyrogen waste treatment and electrical generation combination of systems” 31.

As described above, the “Special Pyrogen waste treatment and electrical generation combination of systems” 31 is comprised of one or more pyrolytic combustion systems with a feed stock and a means to convey and pre-treat the feedstock to the pyrolytic combustion system and in which the pyrolytic combustion system produces a syngas; one or more co-generators that produce hot water and electrical power in which the co-generator systems which may be powered from a syngas; a means to transfer the resultant syngas or pyrogas from the pyrolytic combustion system to the cogeneration hot water and electrical power generator; a means to transfer hot water and electricity from the cogeneration hot water and electrical power generator to the pyrolytic combustion system; and a means to transfer generated electricity from the co-generator to an end user wherein feedstock is fed into the pyrolytic combustion system and electricity is produced to the end user by the cogeneration electrical power generator.

This system has various feed stocks 60 introduced to the system 31. These feed stocks 60 include for example and not limitation wastes such as shown in Table D:

TABLE D
Various feed stocks

| ITEM | Description |
|---|---|
| 1 | Automotive Shredder Residue (ASR) |
| 2 | Municipal Solid Waste (MSW), |
| 3 | Animal Waste from Concentrated Animal Feeding |
| | Operations (CAFO's), |
| 4 | City sewage sludge |
| 5 | Food plant DAF waste sludge and solid materials |
| 6 | Agricultural manures |
| 7 | Non-recycle-able plastics |
| 8 | Used tires |
| 9 | Fabric and carpet |
| 10 | Paint |
| 11 | Feathers |
| 12 | Paper and wood products |
| 13 | Plant stalks (corn, soy beans, etc) |
| 14 | variety of other organic waste streams |

Example of the various locations to be considered for using the “Special Pyrogen waste treatment and electrical generation combination of systems” 31 is offered as an example and not limitation. Theses are shown in Table E.

TABLE E
Example Locations for Use of the combined system

| ITEM | DESCRIPTION |
|---|---|
| 1 | Supplement power grids - sell back to power |
| | companies |
| 2 | Stand alone third world applications |
| 3 | Residential neighborhoods - especially new, remote |
| | locations away from existing power grids |
| 4 | CAFOs |
| 5 | Military, defense |
| 6 | Strategic back-up |

The operation of the preferred embodiment of the “Special Pyrogen waste treatment and electrical generation combination of systems” 31 is not easily comprehended. However, the uniqueness as to other prior art should be evident to one skilled in the art of electrical power generation and hot water using waste energy from a pyrolytic conversion systems. The combination is new and unique and not anticipated or obvious in view of other waste and cogeneration systems. The details of the combination of devices and systems were described above.

With this description it is to be understood that the “Special Pyrogen waste treatment and electrical generation combination of system” 31 is not to be limited to only the disclosed embodiment. The features of the “Special Pyrogen waste treatment and electrical generation combination of systems” 31 are intended to cover various modifications and equivalent arrangements included within the spirit and scope of the description.

What is claimed is:

1. A Special Pyrogen waste treatment and electrical generation combination of systems 31 for treating waste and cogenerating electricity comprised of
a). at least one pyrolytic combustion systems with a feed stock and a means to convey and pretreat the feedstock to the pyrolytic combustion system and in which the pyrolytic combustion system produces a syngas;
b). at least one co-generators that produce hot water and electrical power in which the co-generator systems, with a high temperature exhaust gas, may be powered from an energy source syngas;
c). a means to transfer the resultant syngas from the pyrolytic combustion system to the co-generator;
d). a means to transfer electricity from the co-generator to the pyrolytic combustion system;
e) a means to transfer generated electricity from the co-generator to an end user;
f) a means to transfer hot water from the co-generator to an end use device; and
g) a means to transfer the high temperature exhaust gas to the pyrolizer for a use
wherein feedstock is fed into the pyrolytic combustion system and electricity is produced to the end user by the cogeneration electrical power generator which has hot water and high temperature exhaust gas as a by product.

2. The device according to claim 1 wherein the hot water end use device is the collection conveyor.

3. The device according to claim 1 wherein the hot water end use device is a pre-conveyor drying of the waste.

4. The device according to claim 1 wherein the high temperature exhaust gas use is the pyrolysis chamber.

5. The device according to claim 1 wherein the syngas produced is a biogas.

6. The device according to claim 1 wherein the syngas produced is a methane derivative.

7. The device according to claim 1 wherein the syngas produced is a new composite gas resultant of the pyrolytic system.

8. The device according to claim 1 wherein the end user of electricity is a supplement power grid.

9. The device according to claim 1 wherein the user of electricity is a stand-alone power application.

10. The device according to claim 1 wherein the end user of electricity is a residential neighborhood.

11. The device according to claim 1 wherein the end user of electricity is a strategic electrical power back-up operation.

12. The device according to claim 1 wherein the end user of electricity is a power source for military operations.
